(19) United States
(12) Patent Application Publication
(10) Pub. No.: US 2005/0253087 A1
(43) Pub. Date: Nov. 17, 2005

(54) Fluorescence diagnostic system

(76) Inventor: Thomas Plan, Donaustauf (DE)

Correspondence Address: HOFFMAN WASSON & GITLER, P.C;CRYSTAL CENTER 2, SUITE 522, 2461 SOUTH CLARK STREET, ARLINGTON, VA, 22202-3843, US

(21) Appl. No.: 10/485,256

(22) PCT Filed: Aug. 1, 2002
(86) PCT No.: PCT/DE02/02818

§ 371 Date: Mar. 17, 2005

(30) Foreign Application Priority Data
Aug. 9, 2001 (DE) 101 39 239.7
Nov. 23, 2001 (DE) 101 57 575.0

(51) Int. Cl. G01N 21/64

(52) U.S. Cl. 250/458.1

(57) ABSTRACT

The invention refers to a new system for the fluorescent diagnosis of organs or tissues, with at least one light source for providing an excitation light to an examination area and with an optical detector for fluorescence, which due to the excitation light is produced by a fluorescent dye present in the tissue.

The invention pertains to a system for fluorescent diagnosis as claimed in claim 1.

Fluorescent diagnosis is a known process that is still in the experimental stage and not yet clinically approved, but that is very promising for the quantitative early detection of a number of pre-cancerous/dysplastic changes in tissue. Fluorescent diagnosis makes use of the metabolic differences, for example in porphyrin metabolism, between cells in dysplastic/tumorous tissue and cells in normal tissue.

The object of the invention is to present a system to enable improved and more unambiguous fluorescent diagnosis. To achieve this object, a system as claimed in claim 1 is embodied.

The system according to the invention serves to visualize fluorescent dyes for fluorescent diagnosis of human tumors, for example, and is also suitable for the highly sensitive, quantitative early detection of a number of pre-cancerous/dysplastic changes, for which it makes use of the difference, for example in porphyrin metabolism, in cells in dysplastic/tumorous tissue as compared with cells in normal tissue. The system according to the invention furthermore enables greatly simplified work processes with high sensitivity and unambiguous results.

Suitable fluorescent dyes are, e.g. fluorophores, which absorb light in the visible spectral range or near infrared range and emit light in the near infrared range. These fluorophores include especially exogenous dyes, i.e. introduced into the tissue from outside, such as indocyanine green and various porphycenes, and also endogenous dyes, i.e. dyes produced in the tissue, such as 5-aminolevulinic acid induced porphyrins (in particular protoporphyrin IX) etc.

The invention is described in more detail below based on the drawings of sample embodiments, as follows:

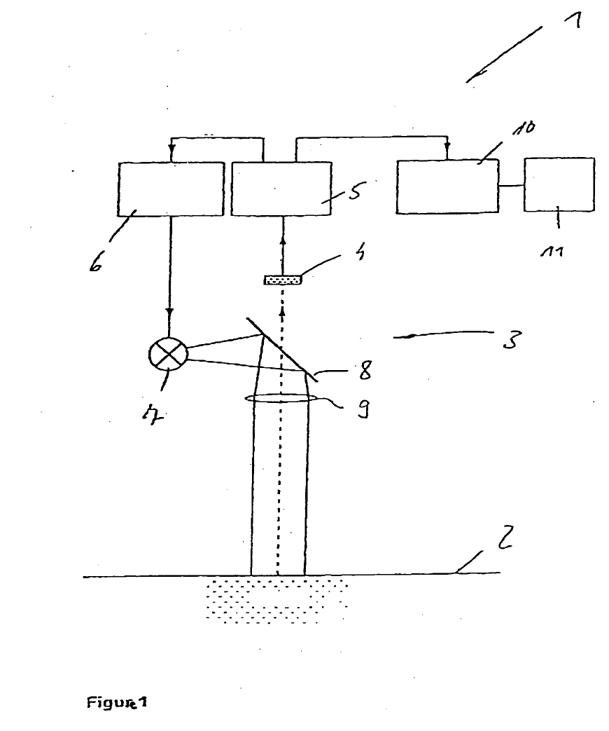

FIG. 1—a schematic representation of a system for fluorescent diagnosis of human tumors according to the invention;

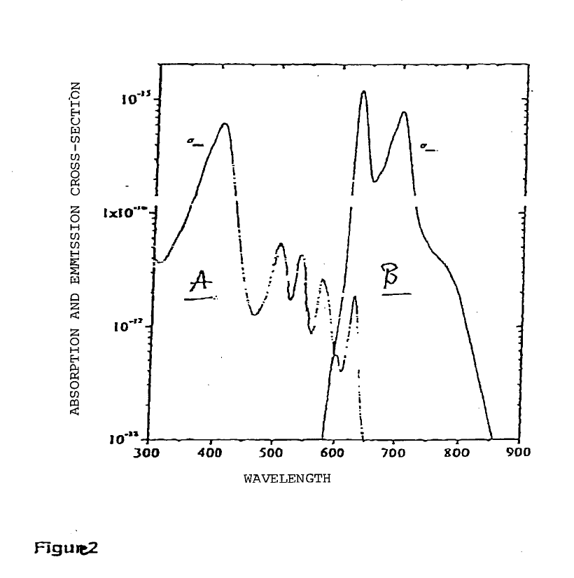

FIG. 2—the spectral range of the absorption and emission for the use of protoporphyrin IX.

The system comprises e.g. a digital camera system 3 with a 3-CCD chip 4 (also RGB chip) as an opto-electric image converter, a first electronic control unit 5 for the camera system 3 and the 3 CCD chip 4, a second electronic control unit 6 for a pulsed light source 7, which provides the excitation light and for example consists of at least one LED or one flash lamp, e.g. xenon high-pressure lamp, or of a laser diode or laser diode configuration.

As FIG. 2 shows, with the use of porphyrins as fluorescent dyes, the maximum absorption for the excitation is in the blue spectral range (approx. 400 nm—range A) and the maximum fluorescent emission is in the red spectral range (approx. 630 nm—range B).

In the beam path or in the optical axis of the camera system 3 there is a beam splitter, which in the depicted embodiment comprises a splitter mirror 8 and by means of which the pulsed excitation light provided by the light source 7 in the optical axis of the camera system 3 is applied through the lens 9 of this system to the object or tissue area 2 to be examined. The beam splitter 8 is designed and configured so that the fluorescent image of the tissue area 2 to be examined impinges through the lens 9 and the beam splitter 8 onto the CCD chip or is depicted in the image plane located there. In this way, the excitation light and the fluorescent light are separated by the beam splitter 8.

The video output of the electronic control unit is connected with a computer 10, to which a monitor 11 is allocated for visualization of the images provided by the camera system 3, namely of the normal color image (also RGB image) and of the fluorescent image of the object 2 to be examined and which also contains the necessary components for presentation of the image on the monitor 11, in particular image memory. The computer 10, which for example is a PC, is allocated other components not depicted, namely the usual keyboard and drives for storage media, such as hard disk, diskettes, tapes, data CDs etc. Furthermore, the computer 10 is also allocated for example means by which a link to data networks or the exchange of data via such networks is possible.

The electronic control unit 5 also has a trigger output, with which the electronic control unit 6 is triggered for the synchronous control of the light source 7. With the described system 1 it is therefore possible to receive a normal image of the tissue area 2 to be examined by means of the camera system 3 with ambient lighting, for example daylight or lamps not depicted, and without any time delay a momentary fluorescent image by triggering the electronic control unit 6, controlled by the electronic control unit 5, and thus the light source 7 for the excitation light. In order to produce the fluorescent image, the electronic control unit 5 at the time of activation of the light source 7 and thus of the fluorescence (activation and fluorescence phase) analyzes only those image signals of the camera system 3 that are present in the channel of the CCD chip corresponding to the spectral range of the fluorescence, i.e. for example if protoporphyrin is used as the fluorescent dye, the signal of the R-channel (channel for the red color signal).

An accordingly short receiving time for the fluorescent images and/or a higher intensity of the fluorescent images make it possible to discriminate the ambient light from these images to the extent that the system functions unambiguously with constant ambient light, i.e. also with ambient light during the excitation and fluorescence phase.

Further decisive advantages of the system consist in the fact that the fluorescent image and the normal RGB image of the overall examination area 2 are detected, digitalized and processed in the computer 10 immediately one after the other, so that it is possible to display both images directly next to each other or one above the other on the monitor 11, so that diseased tissue areas can be displayed in the RGB image without loss of information and orientation.

By means of a threshold calculation performed on the computer 10 it is also possible to clearly emphasize boundaries between healthy and diseased tissue. Important images can be saved on the computer 10 or on storage media and activated with data of the respective patient, for example for the control of therapeutic measures and/or of the course of disease.

The invention was described above based on a sample embodiment. It goes without saying that numerous modifications are possible without abandoning the underlying inventive idea of the invention. For example, it is also possible to configure the light source 7 for the excitation light so that this light is not blended in with the beam path of the camera system 3, but rather impinges outside of this beam path on the object 2 to be examined. In this case, there is preferably a long pass filter (λ>460 nm) instead of the beam splitter 8 in the beam path of the camera system 3 for separating the fluorescent light from the excitation light of the light source 7.

It was assumed above that both the normal RGB image and the fluorescent image can be generated with a single camera system 3 or with a single CCD chip (RGB chip). Of course, it is also possible to provide two camera systems or one camera system with two CCD chips, of which one chip is designed as a 3-CCD chip for generating the normal RGB image or the corresponding image signals and the other chip is designed as a b/w CCD chip for generation of the fluorescent image or the corresponding signal. The electronic control unit 5 has two inputs in this case. The signals of the two CCD chips are then detected in succession by the electronic control unit 5 for generation of the video images sent to the computer 10.

### Reference List

1 system for fluorescent diagnosis

2 object or tissue

3 camera system

4 3-CCD chip

5, 6 electronic control unit

7 light source for excitation light

8 beam splitter

9 camera lens

10 computer

11 monitor

1-14. (canceled)

15. A system for the fluorescent diagnosis of organs and tissues with at least one excitation light source for providing an excitation light to an examination area for a fluorescence, which due to the excitation light is produced by a fluorescent dye present in the tissue, with a camera system for generating a fluorescent image of the examination area using the excitation light and a normal image of the examination area, wherein the camera system has a single opto-electric image converter both for generating the fluorescent image and for generating the normal image under ambient light, and that the excitation light source is a pulsed light source, the light of which is superimposed by the ambient light for the normal image.

16. The system as claimed in claim 15, wherein the normal image and the fluorescent image of the examination area are generated successively in time, the fluorescent image during an excitation and fluorescence phase, in which the at least one excitation light source for emitting the excitation light is activated, and the normal image outside of the excitation and fluorescence phase.

17. The system as claimed in claim 15, further comprising a first electronic control unit for the camera system or the opto-electric image converter.

18. The system as claimed in claim 17, wherein the opto-electric image converter has an RGB output, and the first electronic control unit for generating the fluorescent image analyzes only image signals present at the output of the opto-electric image converter corresponding to the spectral range of the fluorescent image.

19. The system as claimed in claim 17, wherein the electronic control unit receives the image signals generated by the opto-electric image converter as image signals of the fluorescent image synchronously with the activation of the at least one excitation light source, generating images for further image processing.

20. The system as claimed in claim 15, further comprising a second electronic control unit for the at least one excitation light source.

21. The system as claimed in claim 20, further comprising at least one excitation light source and/or the second electronic control unit are triggered by the first electronic control unit.

22. The system as claimed in claim 15, further comprising means for injecting the excitation light of the at least one pulsed excitation light source into the beam path or into the optical axis of the at least one camera system.

23. The system as claimed in claim 22, wherein the means for injecting the excitation light comprises at least one splitter mirror.

24. The system as claimed in claim 15, wherein the opto-electric image converter is a CCD chip.

25. The system as claimed in claim 15, wherein the electronic control unit analyzes the signal of the R-channel of the opto-electric image converter.

26. The system as claimed in claim 15, wherein the spectrum of light of the pulsed light source is in the visible spectral range and/or in the infrared range and/or in the UV range.
